(19) United States
(12) Patent Application Publication
(10) Pub. No.: US 2003/0072906 A1
(43) Pub. Date: Apr. 17, 2003

(54) Adhesive tape, especially packaging tape, with an oriented thermoplastic film-based, single-sidedly adhesive-coated backing

(76) Inventors: Dieter Wenninger, Hamburg (DE); Wolfgang David, Hamburg (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(21) Appl. No.: 10/154,052

(22) Filed: May 23, 2002

(30) Foreign Application Priority Data
Aug. 24, 2001 (DE) 101 41 502.8

(51) Int. Cl. B32B 9/00

(52) U.S. Cl. 428/40.1; 428/77; 428/343

(57) ABSTRACT

An adhesive tape having a backing which is based on an oriented thermoplastic film and is coated on one side with an adhesive, the coated side of the backing bearing at least one strip which is narrow in comparison to the width of the tape and which extends in the longitudinal direction of the tape, the adhesive force of said strip being reduced completely or lessened at least in sections.

The invention relates to an adhesive tape, especially an adhesive packaging tape, having a backing based on an oriented thermoplastic film and coated on one side with an adhesive, the coated side of the backing bearing at least one strip which is narrow in comparison to the width of the tape and which extends in the longitudinal direction of the tape.

Fully coated adhesive tapes, and especially packaging tapes, are state of the art. An overview is given, for example, in “Handbook of pressure sensitive adhesive technology”, second edition, edited by Donatas Satas, Van Nostrand Reinhold, New York, 1989, pages 661 to 674.

A problem which exists with these standard adhesive packaging tapes is that sealed cartons have to be opened by means of cutters, knives, scissors, fingernails or other pointed tools, since rapid opening of the cartons sealed with adhesive packaging tapes, by simple tearing open with the fingers, completely removing the tape, is not a reality. These auxiliary means harbor a risk of injury and/or of damage to the contents of the package.

For simplifying the opening of cartons which carry an adhesive packaging tape, numerous solutions have been proposed, and some implemented.

DE 198 36 221 A1 has achieved easy opening of sealed cartons in such a way that an additional necessity is to manufacture special cartons with predetermined breakage indentations. Where these predetermined carton breakage points are overstuck with adhesive tape in the course of carton sealing, they can easily be disengaged later, as grip tabs, and so remove readily with the adhesive tape.

The invention embraces a blank for a package which features at least one aperture and is made preferably of corrugated cardboard, at least one piece for predetermined severance being formed in the blank such that when the aperture is closed said piece is disposed to the side of the aperture. Also described is a package, preferably of corrugated cardboard, which is or can be sealed with an adhesive strip, at least one end of said strip being firmly adhered or adherable to a severance piece of the package.

In order to open the package when it is sealed with the adhesive strip, therefore, all that need be done is to remove the severance piece from the package. Since the adhesive strip is firmly adhered to said severance piece, sufficient purchase can thus be obtained on the adhesive strip/severance piece, so that the adhesive strip can be peeled off and removed without further difficulty.

In the context of carton blank manufacture, U.S. Pat. No. 6,089,447 A1 proposes bonding special cardboard tabs to the carton which serve as grip tabs after the carton has been sealed with packaging tape.

JP 11 321 817 A1 proposes constructing an automatic packaging machine such that during placement of the end of the adhesive sealing tape a special suction means forms a strap of adhesive tape which is intended to serve as a grip tab when the carton is opened.

A further solution is offered by Soco Systems A/S in Denmark. As an add-on to an automatic carbon sealing machine, it is necessary here to attach a special kit which adheres paper tabs to the end of the adhesive tape during the packaging operation so that easier opening can later be ensured.

For standard cartons, U.S. Pat. No. 5,672,402 A1 uses strippable adhesive strips which protrude when the cartons are sealed. Pulling strongly on the protruding end of these strips causes them to stretch greatly, and thus they are easy to remove because of the subsiding adhesive force. These strips are unsuitable for automatic carton sealing, since the carton sealing units are only able to process adhesive tapes from the roll.

Although systems composed of adhesive packaging tape and tear strips have the advantage that as a result of the tear strip it is easy to tear open the tape on the carton, they do not obviate removal of the residual straps on the sides of the carton, which is laborious.

U.S. Pat. No. 6,159,328 A1 describes, for example, a special dispenser which is able to apply adhesive packaging tape and tear strips to the carton.

Common to all these variants is the disadvantage either that it is not possible to utilize standard cardboard packaging forms or apparatus, and that their use is therefore limited, or that by weakening the cardboard packaging the package is substantially weakened, thereby decreasing the packaging security.

It is an object of the present invention, therefore, to create an adhesive packaging tape, based on an oriented thermoplastic film, which after carton sealing can be removed quickly and easily from the carton without the aid of cutters, knives, scissors or fingernails or other pointed tools, said tape being compatible with standard cardboard packaging forms and standard application machinery and in which the known disadvantages of the prior art are present, if at all, only to a reduced extent.

This object is achieved by means of an adhesive tape as specified in the claims. Developments of the adhesive tape of the invention are subject matter of the subclaims. The invention further embraces possibilies for advantageous use of the adhesive tape.

The invention accordingly describes an adhesive tape having a backing which is based on an oriented thermoplastic film and is coated on one side with an adhesive, the coated side of the backing bearing at least one strip which is narrow in comparison to the width of the tape and which extends in the longitudinal direction of the tape, the adhesive force of said strip being reduced completely or lessened at least in sections.

The lessening or complete reduction in the adhesive force of the strip is preferably accomplished by imprinting the adhesive.

Complete neutralization of the surface of the adhesive—particularly for the purpose of forming a grip tab—may be undertaken by covering it with, for example, thin plastic films, metal foils or paper. Neutralization is preferably realized in accordance with DE 44 31 914 A1, which is hereby expressly incorporated into the disclosure content of this invention.

Alternatively, the regions of the pressure sensitive adhesive that are to be neutralized can be coated or imprinted using a nontacky varnish or a nontacky powderous material.

Neutralization can be carried out such that in the region of the strip or strips the adhesive force of the adhesive tape is low in comparison to that of the other areas of the tape. This can be achieved by deliberately partial imprinting or coating.

In this case, the grip tab regions are provided by the carrier used which is partially coated or imprinted with adhesive in such a way that the grip tab regions do not bond so strongly, if at all, to the surface of the carton.

It is further possible to apply the adhesives in dot formation by means of screen printing (DE 42 37 252 C2), the dots of adhesive being variable in size and/or distribution (EP 0 353 972 B1), by means of gravure printing (DE 43 08 649 C2) of lines which connect in the longitudinal and transverse directions, by means of half tone printing or by means of flexographic printing.

The adhesive can be present on the strip with preference in dome form through screen printing or else may be applied in another pattern such as lattices, stripes, zigzag lines and also, for example, through gravure printing. Additionally, it may have been applied, for example, by spraying, giving a more or less irregular appearance.

In one preferred embodiment the adhesive has been applied to the backing in the form of polygeometric domes.

The domes may have different forms. Flattened hemispheres are preferred. A further possibility is the printed application of different forms and patterns on the backing material: for example, a printed image in the form of alphanumeric symbol combinations or patterns such as lattices, stripes, cumulate domes, and zigzag lines.

By way of example, the adhesive on the strip may carry a full-area coating, a release coating for example.

The concept of the invention further embraces an adhesive tape having a backing which is based on an oriented thermoplastic film and is coated on one side with an adhesive, the coated side of the backing bearing at least one strip which is narrow in comparison to the width of the tape and which extends in the longitudinal direction of the tape, and which is uncoated with adhesive at least in sections.

For the coating of the adhesive it is possible, for example, directly following the wire doctor which is used, to draw off adhesive using a plastic stencil so as to produce a pack of adhesive having, in its longitudinal direction, zones free of adhesive and zones containing adhesive.

In one advantageous embodiment of the invention one strip is located at the edge of the adhesive tape, so producing a markedly protruding grip tab which is easy to recognize and use for anyone wishing to open a carton which is sealed with the adhesive tape of the invention.

The adhesive-force-reduced or adhesive-free strips can be altered accordingly over their entire length, although it is also in accordance with the invention if such alteration takes place only in sections, comparable to a dashed line, with the distances between the individual dashes being freely selectable.

Films which can be employed in accordance with the invention include monoaxially and biaxially oriented films based on polyolefins: films based on oriented polyethylene or oriented copolymers containing ethylene and/or polypropylene units, and also, where appropriate, PVC films, PET films, films based on vinyl polymers, polyamides, polyesters, polyacetals, and polycarbonates.

Films based on oriented polyolefins, monoaxially and biaxially oriented films for example, are used in large amounts for adhesive packaging tapes, strapping tapes, and other kinds of adhesive tape. Films based on oriented polyethylene or oriented copolymers containing ethylene and/or polypropylene units may also be employed as backing film in accordance with the invention.

Monoaxially oriented polypropylene is notable for its very high tensile strength and low elongation in the longitudinal direction and is used, for example, for producing strapping tapes. For producing the adhesive tapes of the invention for the purpose of bundling and palletizing cardboard packaging and other goods, preference is given to monoaxially oriented films based on polypropylene. The thicknesses of the monoaxially oriented, polypropylene-based films are preferably between 25 and 200 μm, in particular between 40 and 130 μm.

Films of monoaxially oriented polypropylene are especially suitable for producing the adhesive tapes of the invention. Monoaxially oriented films are predominantly single-ply, although multi-ply monoaxially oriented films can also be produced in principle. The majority of the known films are one-, two-, and three-ply, although the chosen number of plies may also be greater.

For producing the adhesive tapes of the invention for the purpose of secure carton sealing, preference is given to biaxially oriented films based on polypropylene with a draw ratio in the longitudinal direction (machine direction; MD) of between 1:4 and 1:9, preferably between 1:4.8 and 1:6, and a draw ratio in the transverse direction (cross direction; CD) of between 1:4 and 1:9, preferably between 1:4.8 and 1:8.5.

The moduli of elasticity achieved in the machine direction, measured at 10% elongation in accordance with ASTM D882, are customarily between 1000 and 4000 N/mm², preferably between 1500 and 3000 N/mm².

The thicknesses of the biaxially oriented films based on polypropylene are in particular between 15 and 100 μm, preferably between 20 and 50 μm.

Biaxially oriented films based on polypropylene may be produced by means of blown film extrusion or by means of customary flat film units. Biaxially oriented films are produced both with one layer and with a plurality of layers. In the case of the multilayer films the thickness and composition of the different layers may also be the same, although different thicknesses and compositions are known.

Particularly preferred for the adhesive tapes of the invention are single-layer, biaxially or monoaxially oriented films and multilayer biaxial or monoaxial films based on polypropylene which have a sufficiently firm bond between the layers, since delamination of the layers in the course of application is disadvantageous.

Films based on unplasticized PVC are used to produce adhesive packaging tapes. Plasticized PVC, owing to the inadequate thermal stability of max. 60° C., tends to be unsuited to the production of adhesive packaging tapes but may likewise be used where appropriate.

For the adhesive tapes of the invention which are intended in particular to ensure secure carbon sealing it is preferred to use films based on unplasticized PVC. The thicknesses of the films are preferably between 30 and 100 μm, in particular between 35 and 50 μm.

Polyester-based films, based for example on polyethylene terephthalate, are likewise known and may also be used to produce the adhesive tapes of the invention. The thicknesses of the PET-based films are between 20 and 100 μm, in particular between 30 and 50 μm.

Polyesters are polymers whose base building blocks are held together by ester linkages (—CO—O—). According to their chemical structure, those known as homopolyesters may be divided into two groups:

the hydroxy carboxylic acid types (AB polyesters) and

the dihydroxy dicarboxylic acid types (AA-BB-polyesters).

The former are prepared from only one single monomer by, for example, polycondensation of an ω-hydroxy carboxylic acid 1 or by ring-opening polymerization of cyclic esters (lactones) 2, for example

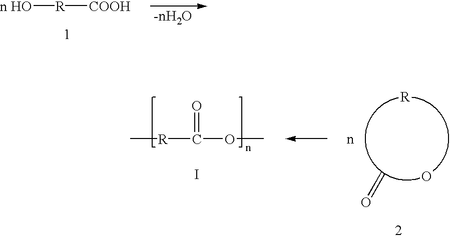

The latter, in contrast, are synthesized by polycondensation of two complementary monomers, such as a diol 3 and a dicarboxylic acid 4:

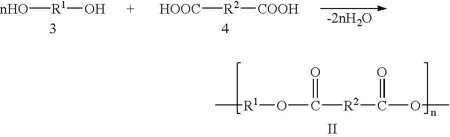

Branched and crosslinked polyesters are obtained in the polycondensation of trihydric or higher polyhydric alcohols with polyfunctional carboxylic acids. The polyesters are also generally considered to include the polycarbonates (polyesters of carbonic acid).

AB-type polyesters (I) include polyglycolic acids (polyglycolides, R═CH2), polylactic acids (polylactides, R═CH—CH3), polyhydroxybutyric acid [poly(3-hydroxybutyric acid), R═CH(CH3)—CH2], poly(ε-caprolactone)s [R═(CH2)5], and polyhydroxybenzoic acids (R═C6H4).

Purely aliphatic AA-BB-type polyesters (II) are polycondensates of aliphatic diols and dicarboxylic acids, used inter alia as products with terminal hydroxyl groups (as polydiols) for the preparation of polyesterpolyurethanes [for example, polytetramethylene adipate; R1═R2═(CH2)4].

Most important industrially in terms of quantity are AA-BB-type polyesters of aliphatic diols and aromatic dicarboxylic acids, especially the polyalkylene terephthalates [R2═C6H4, with polyethylene terephthalate (PET) R1═(CH2)2, polybutylene terephthalate (PBT) R1═(CH2)4 and poly(1,4-cyclohexanedimethylene terephthalate)s (PCDT) R1═CH2—C6H10—CH2] as the most important representatives. By using other aromatic dicarboxylic acids as well (isophthalic acid for example) and/or by using diol mixtures for the polycondensation it is possible to vary the properties of these types of polyester broadly and to adapt them to different fields of application.

Purely aromatic polyesters are the polyarylates, which include poly(4-hydroxybenzoic acid) (formula I, R═C6H4), polycondensates of bisphenol A and phthalic acids (formula II, R1═C6H4—C(CH3)2—C6H4,R2═C6H4) or else those of bisphenols and phosgene.

One example of a suitable backing layer is a metallocene polyethylene nonwoven.

The metallocene polyethylene nonwoven preferably has the following properties:

a basis weight of from 40 to 200 g/m², in particular from 60 to 120 g/m², and/or

a thickness of from 0.1 to 0.6 mm, in particular from 0.2 to 0.5 mm, and/or

an ultimate tensile stress elongation lengthwise of from 400 to 700%, and/or

an ultimate tensile stress elongation crosswise of from 250 to 550%.

The adhesive tapes of the invention may comprise a self-adhesive composition based on natural rubber, PU, acrylates or styrene-isoprene-styrene block copolymers.

The use of adhesives based on natural rubber, acrylates or styrene-isoprene-styrene for packaging tapes is known, this being also described, for example, in the “Handbook of pressure sensitive adhesive technology”, second edition, edited by Donatas Satas, Van Nostrand Reinhold, New York, 1989.

As self-adhesive composition use is made in particular of a commercial pressure sensitive adhesive based on PU, acrylate or rubber.

An adhesive which has proven particularly advantageous is one based on acrylate hotmelt having a K value of at least 20, in particular more than 30, obtainable by concentrating a solution of such an adhesive to give a system which can be processed as a hotmelt.

Concentration may take place in appropriately equipped tanks or extruders; particularly in the case of devolatilization at the same time, a devolatilizing extruder is preferred.

An adhesive of this kind is specified in DE 43 13 008 A1, whose content is hereby referenced and made part of this disclosure and invention. In an intermediate step, the solvent is removed entirely from the acrylate compositions prepared in this way.

Additionally, further volatile constituents are removed. After coating from the melt, these compositions have only a small fraction of volatile constituents. Accordingly, it is possible to adopt all of the monomers/formulas claimed in the above-cited patent. A further advantage of the compositions described in the patent can be seen in that they have a high K value and thus a high molecular weight. The skilled worker is aware that systems with higher molecular weights can be crosslinked with greater efficiency. Accordingly, the fraction of volatile constituents is reduced correspondingly.

The solution of the composition may contain from 5 to 80% by weight, in particular from 30 to 70% by weight, of solvent.

Preference is given to using commercially customary solvents, especially low-boiling hydrocarbons, ketones, alcohols and/or esters.

It is further preferred to use single-screw, twin-screw or multi-screw extruders having one or, in particular, two or more devolatilizing units. Benzoin derivatives may have been incorporated by copolymerization into the adhesive based on acrylate hotmelt: for example, benzoin acrylate or benzoin methacrylate, acrylic or methacrylic esters. Benzoin derivatives of this kind are described in EP 0 578 151 A1.

In addition, however, the adhesive based on acrylate hotmelt may also have been chemically crosslinked.

In one particularly preferred embodiment, copolymers of (meth)acrylic acid and esters thereof having from 1 to 25 carbon atoms, maleic, fumaric and/or itaconic acid and/or their esters, substituted (meth)acrylamides, maleic anhydride, and other vinyl compounds, such as vinyl esters, especially vinyl acetate, vinyl alcohols and/or vinyl ethers are used as self-adhesive compositions. The residual solvent content should be below 1% by weight.

An adhesive which proves particularly suitable is a low molecular mass, pressure sensitive acrylic hotmelt adhesive, as carried under the designation acResin UV or Acronal®, especially Acronal DS 3458, by BASF. This low-K adhesive acquires its application-oriented properties as a result of a final, radiation-chemically initiated crosslinking process.

It is also possible to use an adhesive selected from the group of the natural rubbers or from the group of the synthetic rubbers or consisting of any desired blend of natural rubbers and/or synthetic rubbers, the natural rubber or rubbers being selectable in principle from all available grades such as, for example, crepe, RSS, ADS, TSR or CV types, depending on required purity level and viscosity level, and the synthetic rubber or synthetic rubbers being selectable from the group of randomly copolymerized styrene-butadiene rubbers (SBR), butadiene rubbers (BR), synthetic polyisoprenes (IR), butyl rubbers (IIR), halogenated butyl rubbers (XIIR), acrylic rubbers (ACM), ethylene-vinyl acetate (EVA) copolymers and polyurethanes and/or blends thereof.

Furthermore, in order to improve their processability, the rubbers may preferably be admixed with thermoplastic elastomers in a weight fraction of from 10 to 50% by weight, based on the overall elastomer fraction. As representatives, mention may be made at this point primarily of the particularly compatible styrene-isoprene-styrene (SIS) and styrene-butadiene-styrene (SBS) grades.

As tackifying resins it is possible without exception to use all of the tackifying resins which are known and are described in the literature. As representatives, mention may be made of rosins, their disproportionated, hydrogenated, polymerized, esterified derivatives and salts, aliphatic and aromatic hydrocarbon resins, terpene resins, and terpene-phenolic resins. Any desired combinations of these and other resins may be used in order to adjust the properties of the resultant adhesive in accordance with what is desired. Explicit reference is made to the depiction of the state of the art in the “Handbook of Pressure Sensitive Adhesive Technology” by Donatas Satas (van Nostrand, 1989).

The term “hydrocarbon resin” is a collective designation for thermoplastic polymers which are colorless to intense brown in color and have a molar mass of generally <2000.

They may be divided according to their provenance into three main groups: petroleum resins, coal tar resins, and terpene resins. The most important coal tar resins are the coumarone-indene resins. The hydrocarbon resins are obtained by polymerizing the unsaturated compounds that can be isolated from the raw materials.

Also included among the hydrocarbon resins are polymers obtainable by polymerizing monomers such as styrene and/or by means of polycondensation (certain formaldehyde resins), with a correspondingly low molar mass. Hydrocarbon resins are products with a softening range that varies within wide limits from <0° C. (hydrocarbon resins liquid at 20° C.) to >200° C. and with a density of from about 0.9 to 1.2 g/cm³.

They are soluble in organic solvents such as ethers, esters, ketones and chlorinated hydrocarbons, and insoluble in alcohols and water.

By rosin is meant a natural resin which is recovered from the crude resin from conifers. Three types of rosin are differentiated: balsam resin, as the distillation residue of terpentine oil; root resin, as the extract from conifer rootstocks; and tall resin, the distillation residue of tall oil. The most significant in terms of quantity is balsam resin.

Rosin is a brittle, transparent product with a color ranging from red to brown. It is insoluble in water but soluble in many organic solvents such as (chlorinated) aliphatic and aromatic hydrocarbons, esters, ethers, and ketones, and also in vegetable oils and mineral oils. The softening point of rosin is situated in the range from approximately 70 to 80° C.

Rosin is a mixture of about 90% resin acids and 10% neutral substances (fatty acid esters, terpene alcohols, and hydrocarbons). The principal rosin acids are unsaturated carboxylic acids of empirical formula C20H30O2, abietic acid, neoabietic acid, levopimaric acid, pimaric acid, isopimaric acid, and palustric acid, as well as hydrogenated and dehydrogenated abietic acid.

The proportions of these acids vary depending on the provenance of the rosin.

As plasticizers it is possible to use any plasticizing substances known from adhesive technology. These include, inter alia, the paraffinic and naphthenic oils, (functionalized) oligomers such as oligobutadienes, oligoisoprenes, liquid nitrile rubbers, liquid terpene resins, vegetable and animal oils and fats, phthalates, and functionalized acrylates.

For the purpose of thermally induced chemical crosslinking it is possible to use any known, thermally activatable chemical crosslinkers such as accelerated sulfur systems or sulfur donor systems, isocyanate systems, reactive melamine resins, formaldehyde resins, and (optionally halogenated) phenol-formaldehyde resins and/or reactive phenolic resin or diisocyanate crosslinking systems with the corresponding activators, epoxidized polyester resins and acrylic resins, and also combinations thereof.

The crosslinkers are preferably activated at temperatures above 50° C., in particular at temperatures from 100° C. to 160° C., with very particular preference at temperatures from 110° C. to 140° C.

Alternatively, the crosslinkers may be thermally excited by means of IR radiation or high-energy alternating fields.

In one preferred embodiment of the adhesive tape the adhesion of the adhesive on the preferred thermoplastic film based on polyolefins is improved by means of corona treatment or, very particularly, by means of flame pretreatment, since the surfaces of films based on oriented polyolefins in particular can be treated by means of these widely known processes, such as corona or flame treatment.

Preference is give to surface treatments by means of flame pretreatment. An overview of the processes for surface treatment is contained, for example, in the article “Surface pretreatment of plastics for adhesive bonding” /A. Kruse; G. Krüger, A. Baalmann and O. D. Hennemann; J. Adhesion Sci. Technol., Vol 9, No 12, pp 1611 to 1621 (1995).

The flaming installation comprises at its core a coolable burner unit and a likewise coolable treatment roll, which serves to guide the web. While the burner temperature in the course of flaming is held at between 30° C. and 40° C., the cooling of the treatment roll ensures temperatures there of between 10° C. and 15° C.

The film web is guided and treated between burner and treatment roll under defined conditions. The flaming of the abovementioned polyolefin films takes place by way of a fuel gas/air mixture in optimized composition. The fuel gas fraction comprises gaseous hydrocarbons such as propane or butane or hydrocarbon mixtures in the form, for example, of standard commercial natural gas. Depending on the precise composition of the fuel gas/air mixture, flame temperatures of between 750° C. and 900° C. are obtained. The distance between the burner unit and the treatment roll may be regulated between 2 mm and 7.5 mm. Web speeds can be set within the limits from 30 m/min up to several hundred m/min.

An upper limit results from the capacity of the available installation, i.e., the total installation including coating section in the case of inline backing treatment, or the flaming installation in the case of offline backing pretreatment.

The lower limit is governed by the thermal sensitivity of the film material. The energy input can be varied by way of the volume flow of the mixture, at given settings for mixture composition, burner distance, and web speed, within limits from 20 m³/h to 50 m³/h. In addition, the effective flaming width can be adjusted to different film widths by way of an adjustable burner boundary.

Backing material flamed under optimized parameters is coated with self-adhesive composition no later than one day following pretreatment. A similar procedure is followed for comparative material which has been appropriately corona-pretreated.

In one preferred embodiment of the adhesive tape, adhesion of the adhesive to the thermoplastic film is improved by applying a layer of a primer between the thermoplastic film and the adhesive layer.

In another preferred embodiment of production of the adhesive tapes of the invention, the thermoplastic film carries a commercially customary release coating. Commercial release coatings are composed, for example, of polyvinyl stearylcarbamate as release component.

The adhesive tapes of the invention are suitable for a large number of adhesive tape applications.

One important field of application is that of packaging. The adhesive tapes are suitable as carton sealing tapes, general adhesive packaging tapes, strapping tapes, and adhesive tapes for sealing plastic packs and plastic pouches.

The adhesive tapes are suitable for securing pallets. Further applications are the bundling of loose goods and goods for transportation, such as pipes, planks of wood, etc. The adhesive tapes of the invention may be used to secure, for example, refrigerators and other electrical and electronic appliances when in transit. Further applications are label protection, surface protection, in the construction sector, for example, and tear-open strips for packaging. Applications within the office sector are also possible.

The adhesive packaging tapes have running lengths in particular of 66, 100, and 1000 m. Customary roll widths chosen are 18, 24, 36, 48, 50, and 72 mm.

The preferred colors are brown, white, and transparent. Printing is carried out on rolls with a width of 144 or 150 mm, which are then in turn cut to the abovementioned widths.

The intention of the text below is to illustrate the invention, with reference to examples, without wishing unnecessarily to restrict the invention.

The parameters specified in the examples were measured by means of the following methods.

Water Content

The water content of the adhesive is determined according to the known method of Karl Fischer. A known quantity of the adhesive is heated and the water expelled is determined by titration using the Karl Fischer reagent.

Application Rate

In order to determine the application rate a circular specimen of known surface area is cut from the coated film and weighed. The adhesive is then removed using acetone and the film, now free of adhesive, is reweighed. The application rate, in g/m², is calculated from the difference.

Bond Strength on Steel

The bond strength on steel is measured in accordance with DIN EN 1939 and in analogy to AFERA 4001.

Shear Strength Measurement

The cohesion is determined by means of the PSTC 7 (holding power) shear strength measurement. All values stated were measured at room temperature under a load of 10N with a bond area of 20×13 mm². With this measurement method, good cohesion corresponds to a holding time of >500 min.

Security of Sealing

Using the adhesive tape, standard cartons, such as kraftliner cartons type 24N 515 from Nestler Wellpappe with the dimensions length=425 mm, width=325 mm, and height=165 mm, filled with 20 kg of peas, are sealed with one top and one bottom strip of adhesive in a commercial automatic carton sealing machine from Siat/Italy, or using a commercial manual adhesive packaging tape dispenser from tesa AG, and stored at room temperature or 40° C. for 30 days. If none of the adhesive tape seals has parted in this time, security of sealing is satisfactory.

Tack with Respect to Paper

The adhesive tape under investigation is bonded to the surface of the carton and pulled off by hand at an angle of 160°. The area on the adhesive tape of the fibers that have been torn out is then estimated in %. If this area is >40%, the adhesive tape is said to have good tack.

Openability

The openability of the cartons sealed as per the section on Security of sealing is subsequently assessed by seeing whether the carton can be opened easily and quickly, without additional opening means such as cutters or other pointed objects, by grasping the adhesive-free areas of the carton.

### EXAMPLES:

### 1st Example

A transparent, biaxially oriented polypropylene film, Radil T 28 from Radici, Italy, is used:

| Thickness: | 28 μm |
|---|---|
| Basis weight: | 25 g/m² |
| Tensile strength, MD*: | 167 N/mm² |
| Tensile strength, CD**: | 277 N/mm² |
| Elongation at break, MD: | 135% |
| Elongation at break, CD: | 57% |

*MD = machine direction, i.e., lengthwise
**CD = cross direction, i.e., crosswise

The surface tension of the film surface which is coated with the adhesive is 39 mN/m.

The adhesive used is an aqueous acrylic dispersion from Rohm and Haas bearing the designation Primal PS83D (solids content: 53% by weight; ammonia content: <0.2% by weight; pH: 9.1 to 9.8).

The adhesive is applied to the film using a wire doctor blade. The doctor blade and the coating speed are adjusted such that an application rate of about 24 g/m² is measured after the coated film has been dried. Coating speed and dryer output are set such that, after drying, the adhesive when measured is found to have a water content of from 0.03 to 0.13% by weight.

### 2nd Example

In order to obtain an adhesive packaging tape with zones free of adhesive force, rolls of adhesive tape 150 mm wide were produced in accordance with example 1. These 150 mm wide adhesive tape rolls were inserted into a printing machine for adhesive tape printing in such a way that the printing roll prints directly onto the adhesive. In order to avoid transfer of adhesive to transport shafts or deflection shafts, all of the shafts over which the adhesive side of the tape is directly guided are provided with a commercial antiadhesive silicone adhesive tape, tesa 4563 from tesa AG.

As a result of the forming of the printing plate of the printing roller, and subsequent slitting to final rolls 50 mm wide, the adhesive side is printed with black printing ink of series 15 VAA from Michael Huber GmbH, Germany, such that a roll of adhesive tape 50 mm wide acquires a tack-free zone of 1 cm on the adhesive side.

### 3rd Example

In order to obtain an adhesive packaging tape with zones free of adhesive force, rolls of adhesive tape 50 mm wide were produced as in example 1. However, in the course of application of the adhesive, a plastic stencil was used directly following the doctor blade to take off adhesive in such a way as to produce a package of adhesive tape with adhesive-free zones and zones containing adhesive, in the lengthwise direction with respect to the package, leading after slitting to rolls from which it is possible to produce a 50 mm adhesive tape having a 10 mm adhesive-free zone on one side of the roll.

### 4th Example

In order to obtain an adhesive packaging tape with zones free of adhesive force, rolls of adhesive tape 50 mm wide were produced as in example 1. However, in the course of application of the adhesive, a plastic stencil was used directly following the doctor blade to take off adhesive in such a way as to produce a package of adhesive tape with adhesive-free zones and zones containing adhesive, in the lengthwise direction with respect to the package, leading after slitting to rolls from which it is possible to produce a 50 mm adhesive tape having a 10 mm adhesive-free zone on one side of the roll.

Results of the examples

| | Experiment | | | |
|---|---|---|---|---|
| | 1 not | Experiment | Experiment | Experiment |
| Property | inventive | 2 inventive | 3 inventive | 4 inventive |
| Water content | 0.08 | 0.08 | 0.08 | 0.08 |
| of the adhesive | | | | |
| [g/m²] at | | | | |
| non-tack-free | | | | |
| sites | | | | |
| Application | 24 | 24 | 24 | 24 |
| rate of the | | | | |
| adhesive | | | | |
| [g/m²] at | | | | |
| non-tack-free | | | | |
| sites | | | | |
| Bond strength | 2.8 | 2.8 | 2.8 | 2.8 |
| [g/m²] at | | | | |
| non-tack-free | | | | |
| sites | | | | |
| Security of | | | | 600 min |
| sealing | | | | |
| After 30 days | satis. | satis. | satis. | |
| at RT | | | | |
| After 30 days | satis. | satis. | satis. | |
| at 40° C. | | | | |
| Shear strength | 600 min | 600 min | 600 min | good |
| at non-tack-free | | | | |
| sites | | | | |
| Tack with | good | good | good | |
| respect to | | | | |
| paper | | | | unsatis. |
| at non-tack-free | | | | unsatis. |
| sites | | | | |
| Openability | | | | |
| after 30 days | possible with | easy at tack- | easy at tack- | easy at tack- |
| at RT | difficulty | free site | free site | free site |
| after 30 days | possible with | easy at tack- | easy at tack- | easy at tack- |
| at 40° C. | difficulty | free site | free site | free site |

What is claimed is:

1. An adhesive tape having a backing which is based on an oriented thermoplastic film and is coated on one side with an adhesive, the coated side of the backing bearing at least one strip which is narrow in comparison to the width of the tape and which extends in the longitudinal direction of the tape, the adhesive force of said strip being reduced completely or lessened at least in sections.

2. The adhesive tape as claimed in claim 1, wherein the lessening or complete reduction in the adhesive force of the strip is accomplished by imprinting the adhesive.

3. An adhesive tape having a backing which is based on an oriented thermoplastic film and is coated on one side with an adhesive, the coated side of the backing bearing at least one strip which is narrow in comparison to the width of the tape and which extends in the longitudinal direction of the tape, which is uncoated with adhesive at least in sections.

4. The adhesive tape as claimed in claims 1 or 3, wherein a strip is at the edge of the adhesive tape.

5. The adhesive tape as claimed in claim 1 or 3, wherein the thermoplastic film is composed of biaxially oriented HDPE, unplasticized PVC or PET, of monoaxially oriented polypropylene or biaxially oriented polypropylene.

6. The adhesive tape as claimed in claim 1 or 3, wherein the thermoplastic film used has a thickness of from 25 μm to 200 μm.

7. The adhesive tape as claimed in claim 1 or 3, wherein a layer of a primer is applied between the thermoplastic film and the adhesive layer.

8. The adhesive tape as claimed in claim 1 or 3, wherein said adhesive is an adhesive based on natural rubber, acrylates or styrene-isoprene-styrene block copolymers.

9. A method of sealing a carton, which comprises sealing said carton with the adhesive tape of claim 1 or 3.

10. A method of bundling and palletizing packaged goods, which comprises strapping said goods with the adhesive tape of claim 1 or 3.
